(19) United States
(12) Patent Application Publication
(10) Pub. No.: US 2015/0324103 A1
(43) Pub. Date: Nov. 12, 2015

(54) Social network system for sharing fashions

(71) Applicants: Warangkana Tepmongkol, Santa Clara, CA (US); Michael Richard Mruzik, Santa Clara, CA (US)

(72) Inventors: Warangkana Tepmongkol, Santa Clara, CA (US); Michael Richard Mruzik, Santa Clara, CA (US)

(21) Appl. No.: 14/545,466

(22) Filed: May 7, 2015

Related U.S. Application Data
(60) Provisional application No. 61/996,519, filed on May 9, 2014.

(51) Int. Cl. G06F 3/0484; G06T 11/60

(52) U.S. Cl. CPC G06F 3/04847; G06F 3/04842; G06T 11/60; G06T 2200/24; G06T 2207/20092; G06T 2207/30196

(57) ABSTRACT

A system comprising a software application which can be installed on communications devices to create a social network to share the appearances of an exclusive social group as represented by avatars dressed in virtual clothing and exchanging social commentary on same. Avatars, virtual clothing, and social commentary, as well as various combinations thereof are stored in a virtual closet. Personal looks are created in a virtual dressing room and a determination made as to how clothes fit using fitting algorithms. Infrastructure for a social network is provided wherein comments, opinions, advice, recommendations, and other such information related to personal looks can be exchanged in real time or by messages and data files to be read at a later time. Also included are means to ensure the privacy of an avatar. Also included are a means to estimate physical characteristics of clothing and from a virtual clothing representation.

REFERENCES CITED

| | | |
|---|---|---|
| U.S. Pat. No. 8,700,705 | Apr. 15, 2014 | Danezis, et al. |
| U.S. Pat. No. 8,694,899 | Apr. 8, 2014 | Goossens, et al. |
| U.S. Pat. No. 8,694,656 | Apr. 8, 2014 | Douillet, et al. |
| U.S. Pat. No. 8,694,542 | Apr. 8, 2014 | Tiu, Jr., et al. |
| U.S. Pat. No. 8,621,368 | Dec. 31, 2013 | Shuster, et al. |
| U.S. Pat. No. 8,621,019 | Dec. 31, 2013 | Nguyen, et al. |
| U.S. Pat. No. 8,612,303 | Dec. 17, 2013 | Perlmuter |
| U.S. Pat. No. 8,543,531 | Sep. 24, 2013 | Baker, et al. |
| U.S. Pat. No. 8,521,612 | Aug. 27, 2013 | Walker, et al. |
| U.S. Pat. No. 8,473,550 | Jun. 25, 2013 | Nguyen, et al. |
| U.S. Pat. No. 8,438,081 | May 7, 2013 | Gray, et al. |
| U.S. Pat. No. 8,412,772 | Apr. 2, 2013 | Nguyen, et al. |
| U.S. Pat. No. 8,386,829 | Feb. 26, 2013 | Baughman, et al. |
| U.S. Pat. No. 8,386,486 | Feb. 26, 2013 | Zhang |
| U.S. Pat. No. 8,346,864 | Jan. 1, 2013 | Amidon, et al. |
| U.S. Pat. No. 8,275,590 | Sep. 25, 2012 | Szymczyk, et al |
| U.S. Pat. No. 8,645,230 | Feb. 4, 2014 | Oliver, et al. |
| U.S. Pat. No. 8,260,684 | Sep. 4, 2012 | Flusser, et al. |
| U.S. Pat. No. 8,224,716 | Jul. 17, 2012 | Walker, et al. |
| U.S. Pat. No. 8,224,707 | Aug. 20, 2008 | Smith, et al. |
| U.S. Pat. No. 8,140,506 | Mar. 20, 2012 | Pennington |
| U.S. Pat. No. 8,068,676 | Nov. 29, 2011 | Zhang, et al. |
| U.S. Pat. No. 8,046,411 | Oct. 25, 2011 | Hayashi, et al. |
| U.S. Pat. No. 7,758,193 | Jul. 20, 2010 | Hsu, et al. |
| U.S. Pat. No. 7,133,839 | Nov. 7, 2006 | Inoue, et al. |
| U.S. Pat. No. 7,089,216 | Aug. 8, 2006 | Overveld |
| U.S. Pat. No. 7,063,263 | Jun. 20, 2006 | Swartz, et al. |
| U.S. Pat. No. 5,974,400 | Oct. 26, 1999 | Kagami, et al. |
| U.S. Pat. No. 5,930,769 | Oct. 7, 1996 | Rose |

### BACKGROUND OF THE INVENTION

Clothing has always been an essential commodity in human societies. But since traditional clothes shopping involves travel to locate desirable items of apparel and checking the fit by trying them on, the process can be frustrating and inefficient. Recently the Internet has revolutionized clothing sales by providing nearly instant access to retail merchants and inventories world-wide. The availability of personal computers and other similar technologies have introduced significant efficiencies; and indeed, computer-aided clothing sales volumes continue to increase.

Another technology which is related to this invention is a scanner of physical objects able to create virtual representations. The wide spread availability of scanners on mobile phones will add the capability to create an avatar or virtual clothing at low cost and in any venue.

The main thrust of online sales offerings by retail vendors, in various guises, has been to move their storefront window displays onto the Internet, occasionally with animated features, but without providing the social networks traditionally used by consumers to make socially acceptable choices. Indeed, the human dynamics of clothes shopping have proved remarkably resistant to change despite the technological advances. For example, group influences conferring social acceptance of one's clothing choices follow largely traditional lines despite recent advances in technology. While online shopping for clothes and accessories over the internet is convenient, frustrations and inefficiencies remain. For example, many articles of clothing purchased over the Internet do not fit properly; and in many instances the consumer can't find any items that do fit.

Most Internet search engines are only able to search for generic categories and cannot easily find items based on individual measurements. In addition, returning an online clothing purchase, for whatever reason to include a bad fit, can be problematic, time consuming and costly. Furthermore, sales notifications are not customized to individual measurements and often even recommend items whose sizes are out stock at a retail store; and, for the individual Internet shopper, it is difficult to imagine how an online purchase will look on oneself, in part because one cannot mix and match with clothing and accessories already owned.

Even with low cost and more accurate measurements represented by avatars, without a social network to communicate the shopping experience remains incomplete since the shopper cannot easily create or share a complete personal look with family and friends; there is no real time social interaction to discuss the look and feel of the article of clothing; and no real time social interaction to work out the tricky human dynamics of a purchase. Without a Social Network and the social support provided, online shopping is an inefficient and lonely experience.

Going to the dressing room of a retail store is not a complete solution, in part because simply taking a picture of oneself wearing an item in a dressing room is a poor visual representation lacking animation and other visual aids; and is not easily shared. In addition, one still cannot mix and match store clothes with items already owned but left behind in the home closet. Furthermore, interaction with friends is typically not in real time but by images and messages accessed at a later time.

### SUMMARY OF THE INVENTION

Rather than simply moving traditional store front windows onto the Internet, this invention instead moves traditional social shopping Cliques with normal human preferences and proclivities onto the Internet. In both cases, the near instantaneous availability of worldwide communications introduces significant efficiencies.

The present invention comprises a system and method for creating a social network for sharing fashions. The system comprises means for creating avatar and virtual clothing files; means for uploading and storing these files in computer memories; means for creating a virtual closet to store and organize avatar and virtual clothing files; means for creating a virtual fitting room for combining selected avatar and virtual clothing files to create personal looks, means to protect the privacy of avatars and personal looks, means to determine the physical characteristics of apparel using a “pinch-test”, means to create social “Cliques”, means to exchange fashion information in a real time social setting, and a means to increase the volume of available virtual clothing using “scan-atars”.

Avatars and virtual clothing can be created using scanners most efficiently from mobile phones. These measurements of an individual's bodily dimensions as well as articles of clothing provide accurate digital representations in formats suitable for further computer processing. These can be uploaded to and stored in various memories to include those on mobile phones, other computers, or a central data base accessible over the Internet.

Virtual clothing may originate from scans of various physical items to include those in a retail store or those already owned or borrowed, as from a home closet; and further may include makeup and styling. Alternatively, virtual clothing already in digital format may be obtained directly from retail vendors, from a central data base, from “scan-atars” or from other members of one's clique, or from the general public. Alternatively, a visual representation of the apparel, as for instance a picture or animation on the Internet, may be used to create an article of “virtual clothing”.

Once avatars and virtual clothing have been uploaded into memory, to include that on a mobile phone, or other computer, or a central data base, these items can be stored in a virtual closet.

This invention allows for the creation of personal looks by combining avatars and virtual clothing from a virtual closet in a virtual fitting room. This invention thus allows a wide variety of items to be mixed and matched to create a nearly unlimited number of different personal looks. Fitting algorithms can determine the accuracy of the fit in each personal look. A benefit of this invention, with the ability to accurately determine whether an item of virtual clothing will fit a particular avatar, is to significantly reduce the return rate now epidemic in online sales.

Avatars, virtual clothing, and personal looks can be visualized in this invention using computer graphics displays incorporating multi-media combinations of video, voice, background music, text, animation, caricatures, and many other such features. User control of the visualization to include pan, or zoom, or rotation, or viewing the display from different locations, or inverting figures, or other such features, can be provided. Computer algorithms can be used to visualize the accuracy of the fit in general or in detail by color coding loose and tight fitting areas and many other such visualization techniques. Tags can be displayed in various textural or other formats.

Another dimension of the invention is that it allows for the formation of exclusive groups of friends or acquaintances into “Cliques” from which others are excluded or denied access. The organizer and owner of a Clique have the authority to grant or deny access to the Clique and can be called the “Shiek” or “Shiek Cliquer” or “Chic Cliquer”. This application permits the formation of a nearly unlimited number of different Cliques by any individual. In addition, the “Sheik Cliquer” can schedule an online shopping experience and invite “Clique” members with user friendly notification and acceptance messaging. Tags may be used to limit access to avatars even within a “Clique”.

This invention permits items in a virtual closet, including those from a retail vendor, to be exchanged with fellow clique members so they can try on suggestions. All these items can also be tagged so that the chain of referrals can be tracked. In the event of a purchase, these tags can be used to generate referral fees from the retail vendor or to reimburse the person making the recommendation or to reimburse the “scan-atar” who created the virtual representation in the first place. Many other types of tags can also be applied to include desirability of purchase and other social considerations.

In this invention, privacy issues can be addressed by limiting access to avatars or personal looks to personally selected individuals, or by controlling access via attached tags, or by encryption. Alternatively, avatars can include a modesty garment or a surface roughening or feature smoothing data file or algorithm or other similar means intended to afford a degree of privacy. These data files or algorithms, intended to provide a degree of privacy, can be attached to the avatar or included within visual display software whose access is controlled by the owner of the avatar or by their designated representative.

This invention enables the sharing of opinions, advice, and other such interactions on avatars, virtual clothing and personal looks based many different aspects to include appearance, cost, fit, color, season, social status, occasion to wear, personal dimensions, frills, ability to be accessorized, and many considerations of a similar nature within the framework of a “Clique.” This invention permits each Clique member in active session to modify the shared screen. With permission, one can have access to other avatars for the purpose of shopping for them. This invention also permits tagging retail clothes offerings for a friend so they can try on the suggestion. Each piece of clothing can be rated and additional notes or opinion can be added by me member of the cliques. Also all these items may be shared either in real time or by messages and content accessed at a later time.

The benefits of this invention, with a software application devoted to exchange of opinions related to personal looks, are many and include, for instance, a real time social conversation not limited by the separation from or distance to family and friends or to retail store outlets, not limited by the pressures of other activities or by time of day, not limited by the lack of having one's complete inventory of clothing close at hand, not limited by inaccurate sizes from online retail outlets, and many others.

This invention enables filtering sales notifications from retail vendors to select items that will actually fit and not just a generic type. This technique is called the “pull” model where the customer rather than the vendor initiates a periodic search for information from the Internet. In this case, computer resources come from a distributed base of customer's and thus are automatically scalable with the number of users. A “Comparative Shopping” engine can also be provided which can be programmed to periodically and automatically locate only those items that match the description and actually fit regardless of the advertised size.

This invention can encourage members of the general public, i.e. “scan-atars”, to scan clothing and accessories and to upload those to memories to include mobile devices, other computers, or a central data bases for use within various Cliques using various means to include offering monetary incentives for doing so especially in the event of a purchase.

### DESCRIPTION OF DRAWINGS

This disclosure will present in detail the following description of preferred embodiments with reference to the following figures wherein:

FIG. 1 is a diagram showing the creation of avatars and virtual clothing, where such information however created can be stored, and how such information can be distributed and shared.

FIG. 2 is a diagram showing the inner workings of the application as it makes use of the information described in FIG. 1.

FIG. 3 is a diagram describing how applications from two or more users can interact to share the information of FIG. 1 and FIG. 2 in social settings.

FIG. 4 is a diagram describing how the modesty of an avatar might be protected.

### DESCRIPTION

The invention has been described hereinafter with reference to specific exemplary embodiments thereof. It will, however, be evident that various modifications and changes may be made thereto without departing from the broader spirit and scope of the invention. The specification and drawings are, accordingly, to be regarded in an illustrative rather than a restrictive sense.

Before beginning a detailed description of the invention and its embodiments herein, several terms, some of which have already been used, are here defined to bring clarity to key features:
a) The term “scan” means to use a scanner comprising multiple generators of electromagnetic waves, which can impinge upon a real object and a receiver of the resulting reflections of electromagnetic waves such that the distance to many distinct points on a real object can be determined. This distance information can be assembled into a digital file of position coordinates effectively describing the surface of real objects. The position coordinates or higher level descriptions of the surface separately or together comprise a virtual representation of the real object.
b) The term “avatar” is a two-dimensional (2D) or a three dimensional (3D) representation of an individual with various degrees of detail and precision but attempting to reconstruct as closely as possible the measurements, proportions, color, texture, strength, elasticity and other such physical and visual features in a data file suitable for reading by a computer. This data file may be used to create a visual image of the individual and may include animations of the avatar as well as caricatures of the avatar which distort or emphasize various features. It may originate from various sources such as a still picture, a video sequence, or a scanner.
c) The term “virtual clothing” is a two-dimensional (2D) or three-dimensional (3D) representation of items of clothing or accessories, to include clothing diagrams or patterns, shoes, handbags, scarves, jewelry, and other such items, in a data file suitable for reading by a computer which may be used to create a visual image of these items or is the image itself and may include animations and caricatures of the same. Virtual clothing may also include such features as makeup and styling
d) The term “virtual closet” is a collection of avatars, virtual clothing, personal looks, and comments, advice, suggestions, and recommendations or other such social interaction records related to same stored in a memory to include a mobile device, other computer, or central data base.
e) The term “fit” is defined as fit of the virtual clothing to the avatar regardless of size or shape and is typically available at a fine level of digital detail. A fit is not simply wrapping the garment over the avatar without regard for the relative dimensions of both.
f) The term “virtual dressing room” means a software application which combines an avatar with virtual clothing and estimates the accuracy of a fit between the two to include highlighting the accuracy of the fit by color code, or by numerical tables, or by other similar means.
g) The term “personal look” is an avatar alone or in combination with various items of virtual clothing to include such items as makeup and styling.
h) The term “tag” can be information attached to an article of virtual clothing. The term “tag” as applied to virtual clothing may include items of interest for social discussion to include the retail store, price, size, color, availability, with who shared, desirability for purchase, age, condition, relation to current fashion, and many other such identifying aspects. These tags can also be used to reimburse members of a “Clique” whose recommendations result in a purchase. Tags can be used to manage referral fees for retail sales. Tags can also be used to reimburse “scan-atars” who scan clothing and accessories to create virtual representations.

The term “tag” as applied to avatars can include such information as generalized body type, fits to article of clothing, recommendations for styles dependent on individual dimensions and intended to highlight or hide various features or impressions, fashion preferences, sales history, other cliques joined, and many other such identifying aspects.

The term “tag” as applied to personal looks can include appearance, cost, fit, color, season, social status, occasion to wear, frills, ability to be accessorized, and many others of a similar nature.
i) The term “Clique” or “Chic Clique” or “Chick Click” means one or more individuals who are able to create, to store, and to share avatars or virtual clothing or personal looks or opinions or comment or advice or recommendations or other social commentary on same while excluding others. In addition, the organizer and owner of a Clique, who has the authority to grant or deny access to the Clique, is the “Shiek Cliquer” or “Chic Cliquer”.
j) The term “social network” is meant to include the exchange of information between two or more individuals communicating in real time or by delayed messages. These social interactions may include discussions on such subjects as appearance, cost, fit, color, season, social status, occasion to wear, personal dimensions, frills, ability to be accessorized, desirability for purchase, the apparent enhancement or diminishment of individual dimensions whether desirable or not, and many such other interactions of a similar nature.
k) The term“Scan-atar” or “Scanatar” or “Shopatar” is an individual who can be enticed to scan an item of apparel from a retail vendor to create an article of “virtual clothing” for uploading to a mobile device, or other computer, or to a central data base.
l) The term “pinch test” means to create an item of virtual clothing by scanning in which the material is stressed by pinching or grabbing or pulling or stretching or moving a portion of an item by some means so as to be able to estimate its physical characteristics to include such features as elasticity, strength, stretch-ability, and similar considerations. This “pinch test” can be performed by a “scan-atar” who would now be called a “Pinch-atar” when performing this test. An overly aggressive “Pinch-atar” so testing an item already being worn can be reprimanded by the individual wearing the item now called a “Slap-atar”.
m) The term “mobile device” or “mobile phone” typically refers to a mobile smart phone with an embedded computer but can equally well mean any other mobile device with an embedded computer to include laptop computers.

The present invention will be described in terms of illustrative embodiments. Note that the present invention is not limited to these illustrative examples and may be employed in various forms of hardware and software or combinations thereof and may include one or more appropriately programmed general purpose digital computer having a processor and memory and various input and output interfaces.

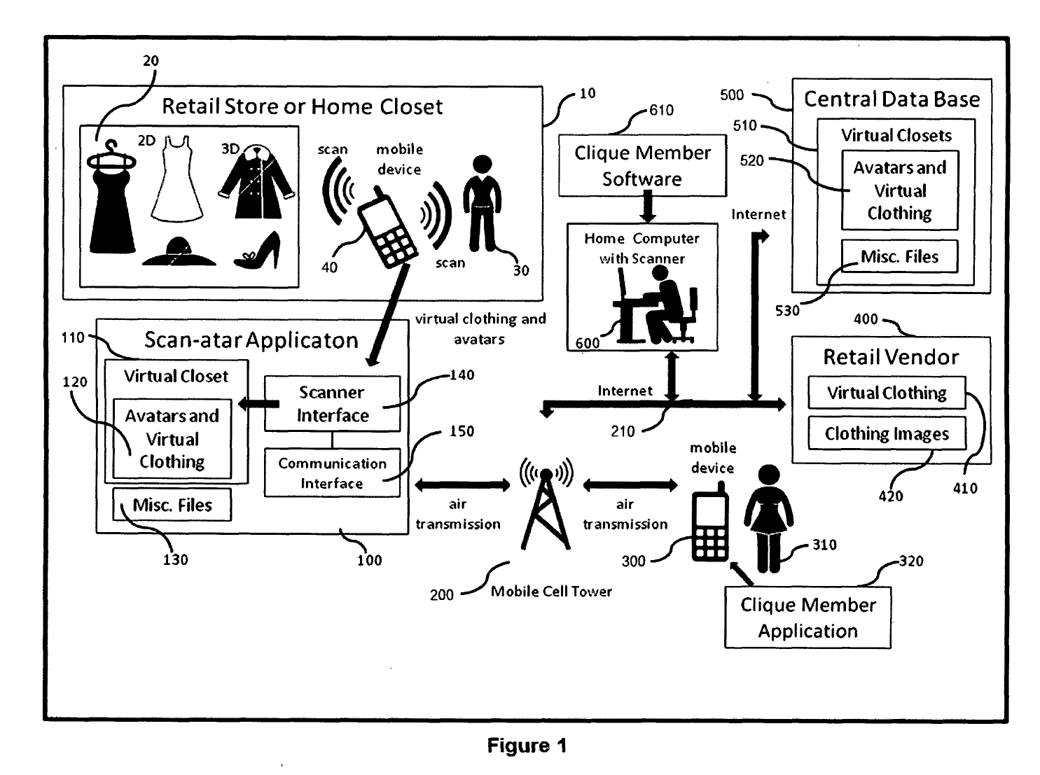

Referring in specific detail to the drawings in which like reference numerals identify similar or identical elements throughout the several views and initially to FIG. 1, a system 10 is described which demonstrates how a scanner creates an avatar and virtual clothing.

Anyone 30, to include an individual called a “scan-atar”, can operate a first scanner 40 to scan physical items of clothing or accessories 20 or oneself or another person 30 to create avatars and virtual clothing. The scanner most efficiently resides on a low cost mobile device 40. The “scan-atar” can be induced to scan retail clothing by various means to include recognition in various forms or for a sales referral fee.

When creating virtual clothing, a “pinch test” can be performed to stress the article of clothing or accessory so as to provide a reference to or estimate of the physical characteristics of an article or accessory in the virtual clothing representation. Most efficiently one would pinch the clothing or accessory with both hands simultaneously at opposite sides and pull on the material to demonstrate such features as strength or elasticity and then scan the resulting configuration. This would provide the fitting algorithms with information related to how the clothes would fit or move on the avatar. The stressed material can be identified as separate from the rest of the article of virtual clothing by noting the position of the hands pinching and pulling or twisting the material or by noting the position of a distinct device used to likewise stress the material.

The clothing 20 can originate from a retail outlet, or from articles of 3D apparel already owned or borrowed, or even from a 2D clothing pattern. These items 20 can be scanned in isolation or while being worn. An avatar can be created by scanning any particular person to include oneself.

This device 40 contains application software 100 with an interface 140 to the embedded application communicating with the scanner hardware. This interface 140 is used to load and store avatars and virtual clothing 120 into a virtual closet 110. Other miscellaneous routines 130, some of which are described later, also reside in the application. A communications interface 150 allows items from the virtual closet to be shared with fellow “Clique” members via air connections 200 or by Internet connections 210, or by other similar means.

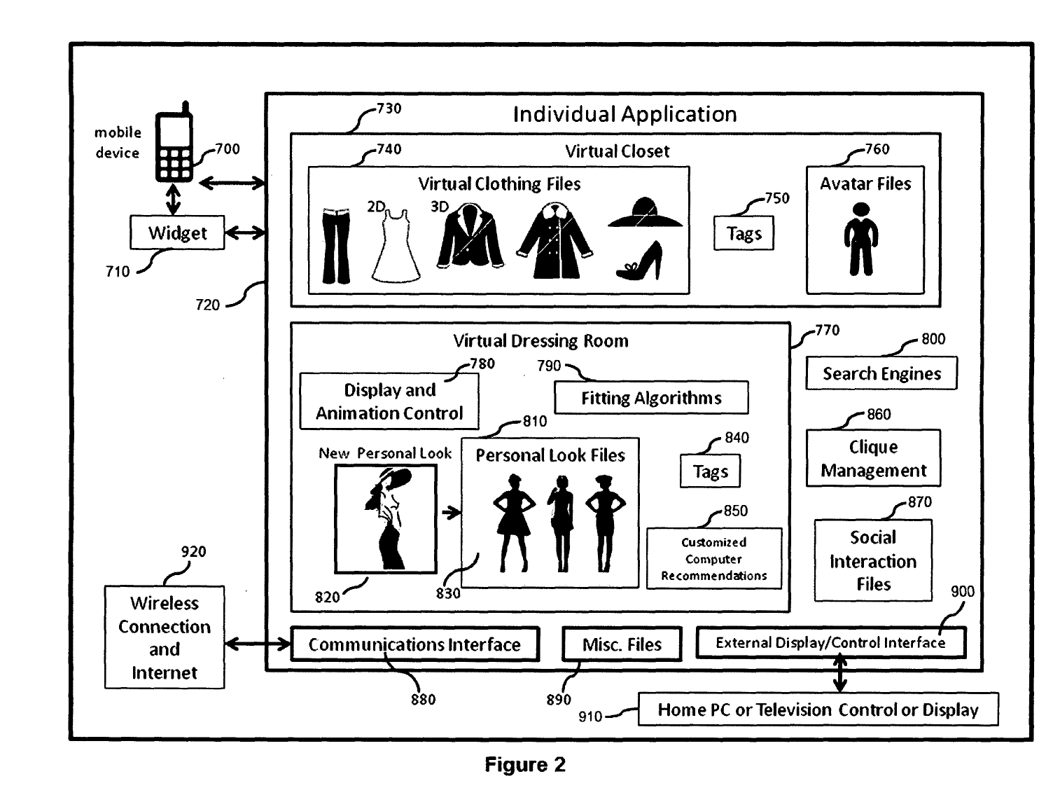

Associated with the process of creating an avatar on a device 40 and transmitting the associated data file over the interface 140, a privacy data file to include a modesty garment or a surface disguising algorithm or data file or a similar feature can be associated with the avatar. And all of these privacy protection schemes can be individually or collectively encrypted. These privacy attachments are intended to modify visualization displays 780 but not to affect the accuracy the later fitting algorithms 790 (see FIG. 2).

Avatars and virtual clothing can be shared between a plurality of Clique members using mobile devices 300 via air connections 200 or using home computers 600 via Internet connections 210 or by similar means. Both computing devices 300 and 600, if present, would contain Clique member applications 320 and 610 respectively with identical features to the “scan-atar” application 100. Alternatively, the “scan-atar” 30 can use a home computer 600 with an Internet connection rather than a mobile device 40.

Each clique member can also be allotted a virtual closet in a central data base 500 accessible via the Internet and allowing a virtual closet 510 of avatars and virtual clothing 520 and other miscellaneous files and applications 530; in addition to the virtual closets in applications residing in various communications devices.

Various communications interfaces to include the Internet connection 210 can also be employed to exchange virtual clothing files 410 between applications on various communications devices and retail vendors 400 or to create virtual clothing by scanning images of clothing 420 from retail vendors.

Referring now to FIG. 2, a second preferred embodiment is presented. An application 720 having the same functionality as item 100 but emphasizing different details is described. This software application 720 would reside most efficiently on a mobile device 700 with a wireless connection but can also reside on a home computer or another computer with an Internet connection. This application 720 can have a software application widget 710 which would provide an interface between the main software application 720 and a user interface or could communicate directly with the user interface.

Within the software application 720, a virtual closet 730 can contain both items of virtual clothing 740 and avatars 760 which can also be stored in separate groupings; and each item or various groupings of items can be tagged 750 with various auxiliary or ancillary data structures and data.

Various items of virtual clothing and avatars can be combined in a virtual dressing room 770 using fitting algorithms 790 to create personal looks 820 which also can be stored in various groupings 830. Fitting algorithms can calculate where a fit can be tight or loose on an avatar and can also indicate how clothes can stretch or deform or move with avatar motion or otherwise behave when worn. Personal looks can be tagged 840 with various auxiliary or ancillary data structures and data to include details of the fit and other such information.

Tags for all of the above items can also include social opinions, comments, advice, and other such social interactions in textual, audio, still picture, or video form or in other similar formats.

Avatars, virtual clothing, and personal looks can be visualized via display and animation control software 780. This user can thus control the orientation of the personal look, view from different perspectives, control other visual features to include panning, zooming, fluffing the virtual clothing, altering the virtual clothing, exaggerating or diminishing various dimensions and features, and other such computer controlled modifications of the personal look. The personal look can also be accompanied by background music or by social interaction information in various forms. Individual aspects of the personal look can be displayed with text commenting on various features or dimensions or offering recommendations or by other visual or audio aids having similar capabilities.

All of the information from the virtual closet 730 and virtual dressing room 770 can be used to create automatically generated computer recommendations 850 typically intended to enhance one's personal look.

All of the information from the virtual closet 730 and virtual dressing room 770 can be used to create a customized search engine 800 operating between mobile devices or the Internet. An automatic periodic check of discounts and other sales promotions can be initialed by the user of the application 720 targeted to items of interest and filtered by details from the fitting algorithm and other such considerations.

The software application 720 would also manage interactions 860 between the “Shiek Cliquer” who originated the “Clique” and other “Clique” members to include management of social interaction files 870. These files can include recommendations for purchase, tags facilitating the reimbursement of the person making the purchase recommendation, tags managing referral reimbursement from retail vendors, and other such similar information.

The application 720 can communicate over a communications interface 880 to other similar applications using various means of connection 920 as well as to various video display devices 910 via a display interface 900 having similar functionality as the display and animation control block 780.

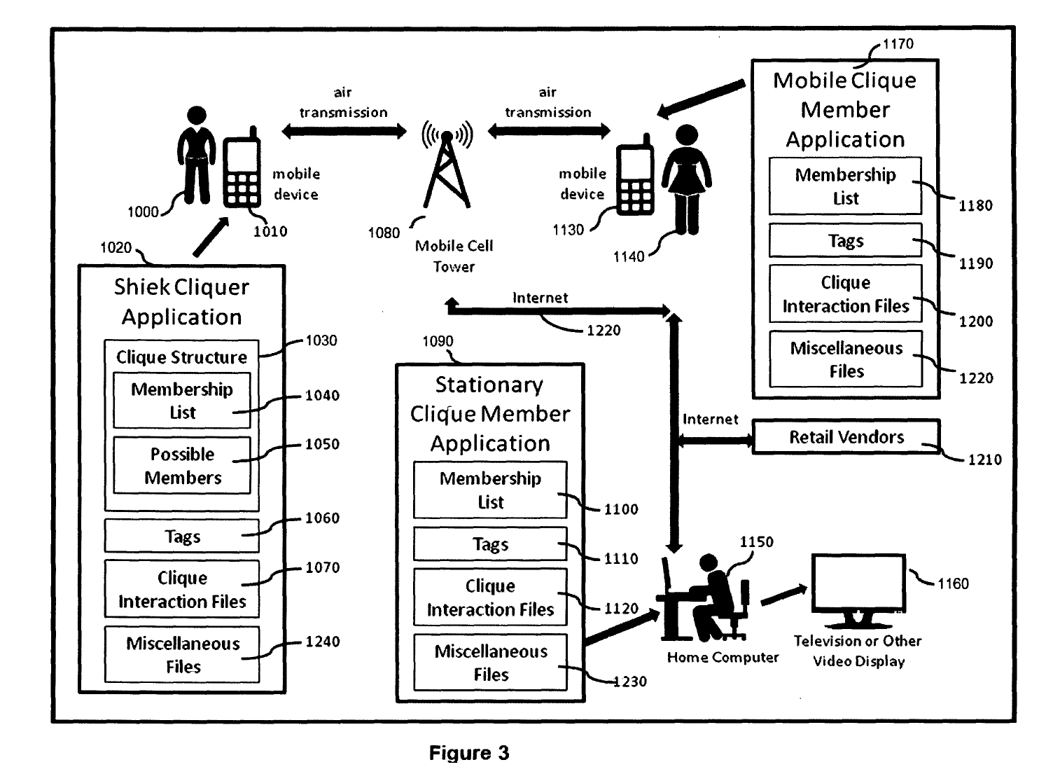

Referring now to FIG. 3, another preferred embodiment is given herein where communications between various “Clique” members are described. The “Shiek Cliquer” or organizer and manager of the “Clique” 1000 can communicate via a communications device to include a mobile device 1010 which includes a software application 1020 with similar functionalities to 100. A “Clique” member 1140 can communicating via a mobile device 1130 which includes the software application 1170; and another “Clique” member 1150 can communicate via a home computer which includes the software application 1090. All clique members can also communicate with retail vendors 1210 and other sites on the Internet.

The software applications shown 1020, 1070, and 1090 reside on their respective communications devices and have the similar functionality as application 100 but emphasize different details as further described. Each application has additional miscellaneous files 1220, 1230, and 1240 not described here. All communications described herein may be wireless 1080 or over the Internet 1220 or employ similar channels of communication.

Anyone with the software application 100 can create a “Clique” or any numbers of “Cliques.” Each software application independently maintains a list 1050 of possible “Clique” members. The “Shiek Cliquer” 1000 can create a software structure 1030 for the active “Clique”, and has the authority to add or remove members from the active “Clique”, and maintains an active “Clique” membership list 1040. The “Shiek Cliquer” can send a current software membership list to each active member of the active “Clique”. Each member of the active “Clique” can view and modify a shared screen in real time or to post messages and information for later access by the active “Clique” members. With permission, each member of the active “Clique” can access virtual clothing and personal looks stored in various virtual closets of the active “Clique” members. With permission, each member of the active “Clique” can have access to various avatars for the purpose of shopping for them. Each member of the active “Clique” can maintain a copy of tags and various “Clique” interaction files, 1060 and 1070 on 1020, 1110 and 1120 on 1090, and 1090 and 1200 on 1070, which contain shared avatars, virtual clothing, personal looks, and opinions, comments, recommendations, and other such social interactions in various formats to include test, video, pictures, video, and in similar forms.

Any and all information from the software applications can be displayed from a mobile device 1010 or a home computer 1150, or other computer, on a television or other video display device 1160.

The miscellaneous software files 130 for the software application 100 can include those that provide recommendations for styles and colors to hide perceived limitations of one's size and shape or to enhance perceptions of one's better feature.

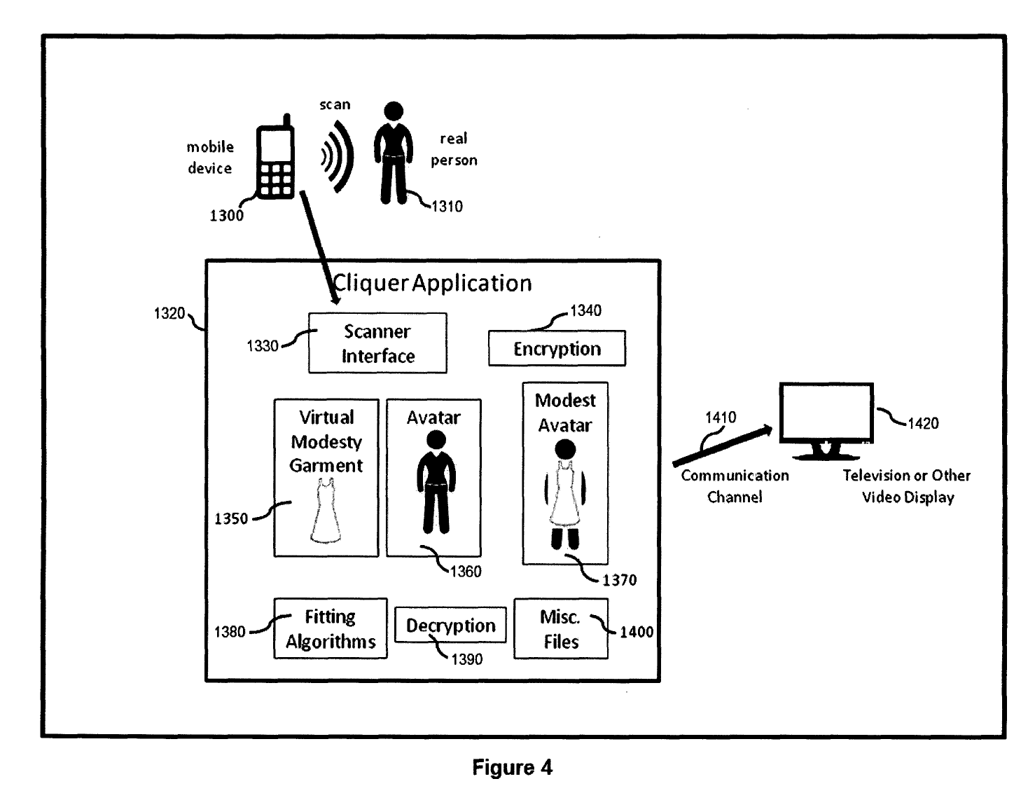

Referring now to FIG. 4, another preferred embodiment is given herein describing means to protect the privacy of an avatar. The application 1320 is similar to 100 and contains various miscellaneous files 1400. A communications device 1300 to include a mobile device can scan an individual 1310 as well as clothing and accessories via some interface 1320 to create an avatar 1360 as well as a virtual clothing modesty garment 1350. Alternatively a data file or an algorithm designed to obscure surface features can be used. But however created, an avatar and virtual modesty garment can be uploaded and stored in an application to include through the scanner interface 1330.

For privacy purposes an avatar can be encrypted 1340 and can also be provided with a means for decryption 1400. A version of an avatar can be dressed in a virtual clothing modesty garment via fitting algorithms 1380 to create a modest avatar 1370. A modest avatar can be encrypted 1340 and can also be provided with a means for decryption 1400. A modest avatar can be decrypted 1400 so the avatar itself can be subsequently used by fitting algorithms 1380.

A modest avatar can be shared over a communication channel 1410 to eventually be stored or visualized on a video display device 1420 to include a mobile device on which it originally resides or on another mobile device. The creator or owner of an avatar can share the means of decryption 1400 for an avatar and a modesty avatar to include with members of a “Clique”.

What is claimed is the following:

1. A system for the creation of a social network for sharing fashions comprising;
(a) means for communicating between an exclusive group of selected individuals;
(b) means for uploading and storing avatar and virtual clothing files in preselected locations including mobile phones, computers or a central data base accessible over the internet;
(c) means for creating a virtual closet to store and organize the avatar and virtual clothing;
(d) means for creating a virtual fitting room for combining selected avatar and virtual clothing files to create personal looks using accurate fitting algorithms;
(e) and means to allow individuals to view avatars, virtual clothing, or personal looks on one's own or someone else's communication devices to include sending copies of avatars, virtual clothing, personal looks, or social commentary on same between communication devices;

2. A method for creating a social network for sharing fashions comprising the steps of;
(a) creating communications methods between an exclusive group of selected individuals;
(b) uploading and storing avatar and virtual clothing files in preselected locations including mobile phones, computers or a central data base accessible over the internet;
(c) creating a virtual closet to store and organize the avatar and virtual clothing;
(d) creating a virtual fitting room for combining selected avatar and virtual clothing files to create personal looks using accurate fitting algorithms;
(e) and creating a the ability of individuals to view avatars, and virtual clothing, or personal looks on one's own or someone else's communication devices to include sending copies of avatars, virtual clothing, personal looks, or social commentary on same between communication devices;

3. A system for including a modesty garment or a surface modification data file or other similar means intended to afford a degree of privacy or modesty, which is included within the avatar data file or is a feature of the visual display software, to include those means which are able to be ignored by fitting algorithms;

4. The system as described in claim 1, which includes a means for creating avatar or virtual clothing files using a 2D pattern, or a visual image or picture, or a 3D scan of the actual item while either alone and separate from an individual or while being worn by an individual, or by other such means;

5. The method as described in claim 2, which includes a means for creating avatar or virtual clothing files using a 2D pattern, or a visual image or picture, or a 3D scan of the actual item while either alone and separate from an individual or while being worn by an individual, or by other such means;

6. The system as described in claim 1, in which an avatar or virtual clothing or personal look can be animated; or viewed from different perspectives or distances; or is able to be expanded or contracted; or in which a portion can be magnified or reduced in size; or in which the pattern or color can be changed; or in which the design can be altered; or to which accessories can be added or subtracted; or other similar visual enhancements of the display;

7. The system as described in claim 1, with a means to allow avatars or virtual clothing or personal looks to be displayed as derived from still pictures or photographs or video or animated icons or along with audio or text or standardized rating systems or statistical summaries of voting results; as well as the means to generate these displays;

8. The system as described in claim 1, with a means in which a personal look can appear against a customized backdrop or inside of an idealized room or inside of a virtual representation of a real room, or in a virtual representation of an outdoor setting whether idealized or real, or in some similar environment. This can include visual representations of furniture to include that offered for sale;

9. The system as described in claim 1, with a means so that avatars, virtual clothing, and personal looks can be shared from a commercial or central data base or from retail vendors;

10. The system as described in claim 1, with a means in which avatars or virtual clothing or personal looks or information or opinions can be tagged with additional information to include store, or price, or size, or color, or availability, or age, or physical condition, or who created it, or with who is authorized for sharing, or with whom shared, or who recommended it, or desirability for purchase, or relation to current fashion, or other similar identifying features;

11. The system as described in claim 1, in which information or opinions are shared in real time or by means of messages containing information or social commentaries which are accessed at a later time;

12. The system as described in claim 1, in which individuals to include family and friends can be organized into “Cliques” to share information or opinions while excluding others; or in which the creator of said “Clique” would have the power to add or delete members of a “Clique”;

13. The system as described in claim 12, using the term “Shiek” or “Chic” to refer to a “Clique”; or “Shiek Cliquer” or “Chic Cliquer” to refer to the organizer of a “Clique”;

14. The system as described in claim 12, in which each “Clique” member can modify the shared screen;

15. The system as described in claim 12, in which each Clique member can, with permission of the creator of a “Clique”, have access to other avatars for the purpose of shopping for them;

16. The system as described in claim 12, wherein inspections of various items, or considerations for purchase, or purchases made by one member of a “Clique” will generate notifications to other members of said “Clique”;

17. The system as described in claim 12, wherein purchases by a member of “Clique” may cause a reimbursement to another member of a “Clique” who recommended the purchase;

18. The system as described in claim 12, with a means that allows the “Shiek Cliquer” to schedule shopping sessions and to generate notification indications to “Clique” members and to receive acceptance messages;

19. The system as described in claim 1, with a means for creating a Comparative Shopping engine with any of the following features:
(a) Those that filter searches for articles of clothing and accessories that are currently offered for sale or have been discounted by a retail vendor.
(b) Those that filter searches for articles of clothing and accessories corresponding to a generalized description.
(c) Those that filter searches for articles of clothing and accessories corresponding to preferences entered by the customer or from prior sales records or Internet search records.
(d) Those that filters searches for articles of clothing and accessories which will fit an avatar to include those that have different tolerances for fitting to different body parts.
(e) Those that filters searches for articles of clothing and accessories which are advertised for sale and are actually available in stock.
(f) Those that filter searches for articles of clothing and accessories which generates automatic and periodic searches that originate with the customer and whose parameters and search intervals can be revised by the customer.
(g) By other similar considerations.

20. The system as described in claim 1, which solicits the general public, or “Scan-atars” to scan items of clothing to create virtual clothing that may be shared with members of a “Clique” or can be uploaded to a central data base.
